(19) United States
(12) Patent Application Publication
(10) Pub. No.: US 2004/0021606 A1
(43) Pub. Date: Feb. 5, 2004

(54) Small plane antenna and composite antenna using the same

(75) Inventor: Makoto Shigihara, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/610,146

(22) Filed: Jun. 30, 2003

(30) Foreign Application Priority Data
Jul. 11, 2002 (JP) 2002-202802
Jul. 11, 2002 (JP) 2002-202838

(51) Int. Cl. H01Q 1/38

(52) U.S. Cl. 343/700 MS; 343/846

(57) ABSTRACT

A composite antenna is formed by combining a circularly-polarized-wave antenna and a vertically-polarized-wave antenna, is suitable for thin and small structure. The composite antenna includes a printed circuit board to which a terrestrial-wave plane antenna as the vertically-polarized-wave antenna is fixed. A satellite-wave patch antenna as the circularly-polarized-wave antenna is fixed to a metal plate of the plane antenna. A power-supply pin of the patch antenna is connected to the power-supply line of a coaxial cable by using an opening of the plane antenna. Circumferentially relative positional relationship between the metal plate and a patch electrode of the patch antenna is set to be almost uniform.

### BACKGROUND OF THE INVENTION

1. Field of the Invention

The present invention relates to a plane antenna suitable for use as a small antenna which is provided on a movable body such as an automobile and which performs terrestrial communication i.e. transmits or receives a broadcast. The present invention also relates to a composite antenna which is provided on a movable body such as an automobile and which can receive or transmit satellite waves and terrestrial waves.

2. Description of the Related Art

Regarding a plane antenna of the above type, as FIG. 5 shows, conventional structures contain a metal plate 10 having a circular exterior shape disposed in parallel with a grounded metal plate 1 above the metal plate 1. The metal plate 10 has a power-supply pin 3 connected to its center as well as a plurality of short-circuiting pins 4 connected to its periphery. The lower end of the power-supply pin 3 is connected to a power-supply line (not shown), and a predetermined high frequency signal is supplied to the center of the metal plate 10. The short-circuiting pins 4 stand to support the metal plate 10, and the short-circuiting pins 4 cause short-circuiting between the periphery of the metal plate 10 and the metal plate 1.

In the conventional plane antenna having the above structure, by appropriately setting the size of the metal plate 10 and the distance between both metal plates 1 and 10 so that the plane antenna is excited in the TE01 mode, which is the lowest resonant frequency mode, nondirectional vertically-polarized radio waves can be emitted in a plane in parallel with both metal plates 1 and 10. Accordingly, by providing the plane antenna on the roof of an automobile, or the like, the plane antenna operates as a thin vertically-polarized-wave antenna which exhibits uniform directional characteristics in an azimuth, so that stable sensitivity can be always obtained, even if terrestrial communication or broadcast reception is performed while the automobile is moving.

As another example of the related art, a plane antenna has been proposed in which the number of components is reduced such that a power-supply pin, short-circuiting pins, and metal plates are integrated beforehand by forming a metal film on the surface of a resin molded item.

In a satellite-broadcast receiving system in a movable body such as an automobile, circularly polarized waves are mainly used. Recently, in order to increase the receiving probability in a dead zone such as the shade of a building, a satellite broadcast system has been proposed which terrestrially re-transmits contents similar to those by direct broadcast waves from a stationary satellite. As an antenna applicable to the satellite-broadcast system, a composite antenna of the related art as shown in FIG. 11 has been proposed.

The composite antenna of the related art in FIG. 11 mainly includes a printed circuit board 14, and a four-wire-wound helical antenna 202 for receiving circularly polarized waves and a monopole antenna 33 for receiving vertically polarized waves as terrestrial waves which stand on the printed circuit board 14. The printed circuit board 14 has, on the almost entire top surface thereof, a ground conductor composed of copper foil or the like. The printed circuit board 14 has a microstrip line on the bottom surface thereof. The helical antenna 202 is formed by a cylindrical block 4 composed of a dielectric that has four spirally-leading helix conductors 55 on its circumferential surface. The helix conductors 55, which are connected to the microstrip line, are supplied with power, with a phase difference of 90 degrees. Since excitation of the helical antenna 202 emits circularly polarized waves upward, the helical antenna 202 can function as a satellite wave receiving antenna. The monopole antenna 33 is formed by standing a linear conductor having approximately a quarter of the wavelength of radio waves used during operation, and connecting the bottom end of the conductor to the microstrip line for power supply. Since excitation of the monopole antenna 33 emits vertically-polarized radio waves uniformly in a plane in parallel with the printed circuit board 14, the monopole antenna 33 can function as a terrestrial-wave receiving antenna.

The conventional plane antenna in FIG. 5 is assembled in a desired shape by joining the power-supply pin 3 and the short-circuiting pins 4 to both metal plates 1 and 10. Thus, the plane antenna in FIG. 5 has problems in that a large number of components deteriorates assembly operability and it is difficult to ensure assembly precision. Also, in the structure that supports the metal plate 10 by the afterward provided short-circuiting pins 4, it is difficult to ensure the mechanical strength required for an in-vehicle antenna. Accordingly, problems easily occur such as a tilt of the metal plate 2 caused by a vibration or impact during a movement of the vehicle.

Also, in the latter case in which, by forming a metal film on the surface of a resin molded item, short-circuiting pins and metal plates are integrated beforehand, assembly precision is easily ensured since the number of components and the number of assembly steps are small and assembly precision is easily ensured. However, the latter case has a problem in that the plane antenna cannot be inexpensively produced because a complicated operation such as deposition or plating must be performed in order to form the metal film on the surface of the resin molded item.

In the above composite antenna of the related art, since the height of the helical antenna 202 is approximately 0.55λ where λ represents the wavelength of radio waves used in operation, when the operating frequency is, for example, 2.3 GHz (λ=130 mm), the height of the helical antenna 202 is approximately 72 mm. This causes a problem in that it is impossible to reduce the height required for use as an antenna provided in a movable body such as an automobile. Also, because the composite antenna has an arrangement that includes both a helical antenna 202 and a monopole antenna 33, a relatively large planar (two-dimensional) size is required. This is to say that, for such an embodiment size reduction is difficult. In addition, the electromagnetic coupling between both antennas 202 and 33 causes the directional characteristics of the monopole antenna 33 to easily deteriorate on the side of the helical antenna 202. Thus, the reception sensitivity of terrestrial waves in that particular azimuth tends to significantly decrease.

### SUMMARY OF THE INVENTION

In view of the above circumstances in the related art, one object of the present invention is to provide an inexpensive plane antenna in which assembly precision and mechanical strength are easily ensured by small numbers of components and assembly steps.

It is another object of the present invention to provide a highly reliable composite antenna for small thin structure which is formed by combining a circularly-polarized-wave antenna and a vertically-polarized-wave antenna.

According to an aspect of the present invention, a plane antenna is provided which includes a printed circuit board, a circular or regular-polygonal metal plate, a ground conductor held at a predetermined distance away from the metal plate, ground terminals which are connected to the ground conductor and which are folded members extended from the metal plate to the side of the ground conductor, a power-supply terminal which are connected to a power-supply line and which is a folded member extended from the metal plate to the side of the ground conductor. The plane antenna is excited in a lowest-resonant-frequency mode to emit vertically polarized radio waves.

Preferably, the printed circuit board has the ground conductor on the top surface thereof, and the metal plate is supported by the printed circuit board, with the ground terminals and the power-supply terminal provided between the metal plate and the printed circuit board.

According to the present invention, a plane antenna is provided which circumferentially emits vertically-polarized radio waves uniformly or substantially uniformly in a plane in parallel with a metal plate. Since the metal plate, ground terminals, and a power-supply terminal can be easily formed by performing blanking on a single sheet of metal and bending the sheet, the number of components and the number of assembly steps are small, and assembly precision and mechanical strength are ensured. Therefore, by providing a movable body such as an automobile with the plane antenna as a thin vertically-polarized-wave antenna for terrestrial waves, various advantages can be expected. These advantages include uniform directional characteristics in an azimuth plane, stabilization of reception sensitivity, mechanical strength, endurance against vibration and impact, and reduction in cost.

According to another aspect of the present invention, a composite antenna is provided which includes a plane antenna and a patch antenna. The plane antenna includes a printed circuit board, a ground conductor, a circular or regular-polygonal metal plate which has an opening in the center thereof, and which is opposed to the ground conductor, with a predetermined distance provided between the metal plate and the ground conductor, ground terminals for connecting the metal plate to the ground conductor, and a power-supply terminal for connecting the metal plate to a first power-supply line. The patch antenna includes a dielectric substrate, a patch electrode provided on the top surface of the dielectric substrate, ground electrodes provided on the bottom surface of the dielectric substrate, an insulating member provided between the metal plate and the dielectric substrate so that the dielectric substrate is fixed to one surface of the metal plate, and a power-supply pin which is provided so as to penetrate the dielectric substrate and to be connected to the patch electrode, and which is connected to a second power-supply line, with the power-supply pin inserted into the opening. The plane antenna is excited to emit vertically polarized radio waves, and the composite antenna is excited to emit circularly polarized radio waves.

Preferably, the printed circuit board has, on the top surface thereof, the ground conductor and a plurality of insertion holes, and the ground terminals, the power-supply terminal, and the power-supply pin are fixed to the printed circuit board, with the ground and power-supply terminals and the power-supply pin inserted into the insertion holes.

According to another aspect of the present invention, a plane antenna is provided that comprises a printed circuit board, a conductive plate, a ground conductor disposed a predetermined distance away from the conductive plate, ground terminals, and a power-supply terminal. The ground conductor is supported by the printed circuit board. The ground terminals and the power-supply terminal extend from and are integral with the conductive plate. The ground terminals connect the conductive plate with the ground conductor. The plane antenna is configured such that characteristics of the plane antenna are substantially uniform when the plane antenna is excited in a lowest-resonant-frequency mode to emit vertically polarized radio waves.

Preferably, the ground conductor is disposed on a surface of the printed circuit board most proximate to the conductive plate and the ground terminals and the power-supply terminal are provided between the conductive plate and the printed circuit board.

Preferably, the conductive plate has a washer shape with inner and outer edges. The ground terminals are formed at the inner edge and the power-supply terminal is formed between the inner and outer edges or the power-supply terminal is formed at the inner edge and the ground terminals are formed at the outer edge. The conductive plate has a substantially circular shape such as a circular shape or a regular-polygonal shape.

A composite antenna comprises the above plane, antenna and a patch antenna. The patch antenna comprises a dielectric substrate, a patch electrode provided on a surface of the dielectric substrate most distal to the plane antenna, ground electrodes provided on a surface of the dielectric substrate most proximate to the plane antenna, an insulating member provided between the conductive plate and the dielectric substrate such that the dielectric substrate is fixed to a first surface of the conductive plate, and at least one power-supply pin provided so as to penetrate the dielectric substrate and to be connected to the patch electrode. The power-supply pin is connected to a second power-supply line and inserted into an opening of the conductive plate. The patch antenna is configured to emit substantially uniform circularly polarized radio waves when excited.

A plurality of insertion holes may be disposed in the printed circuit board, the ground conductor disposed on a surface of the printed circuit board most proximate to the patch antenna, and the ground terminals, the power-supply terminal, and the power-supply pin fixed to the printed circuit board, with the ground and power-supply terminals and the power-supply pin inserted into the insertion holes. The patch antenna preferably has a substantially circular shape and the patch electrode preferably has degeneracy breaking elements positioned to permit the patch antenna to be excited in two orthogonal modes having different resonant lengths and a phase difference of 90 degrees or symmetrically positioned with reference to a center of the patch electrode.

The patch antenna may have a plurality of power-supply pins that are configured excite the patch antenna in two orthogonal modes which have a phase difference of 90 degrees.

Another embodiment is a method of fabricating an antenna structure having substantially uniform characteristics. The method comprises fabricating a plane antenna by: shaping a conductive sheet into a substantially circular shape, blanking portions of the conductive sheet such that a hole is formed in the conductive plate and the conductive plate has inner and outer edges and bending the portions of the sheet to form ground terminals and a power-supply terminal that are integral with the conductive sheet, providing a printed circuit board and a ground conductor supported by the printed circuit board, connecting the ground terminals with the ground conductor, and extending the power-supply terminal toward the ground conductor, thereby providing the plane antenna with substantially uniform characteristics when the plane antenna is excited in a lowest-resonant-frequency mode to emit vertically polarized radio waves.

The method may further comprise forming the ground terminals at the inner edge and the power-supply terminal between the inner and outer edges or forming the ground terminals at the outer edge and the power-supply terminal at the inner edge.

The method may further comprise connecting the ground terminals to a first land on the printed circuit board and the power-supply terminal to a second land on the printed circuit board, the first and second lands disposed on a surface of the printed circuit board opposing a surface of the printed circuit board on which the ground conductor is disposed, the first land connected with the ground conductor and the second land connected to a power-supply line.

Preferably the power-supply terminal is positioned to match impedances of the power-supply terminal and the conductive plate. The antenna structure may be attached to a movable body.

The method may further comprise fabricating a patch antenna. The patch antenna may be fabricated by: attaching a dielectric substrate to the plane antenna with an insulating member disposed between the dielectric substrate and the plane antenna, providing a patch electrode on a surface of the dielectric substrate most distal to the plane antenna and ground electrodes on a surface of the dielectric substrate most proximate to the plane antenna, and inserting a power-supply pin through the dielectric substrate and the opening of the conductive plate and connecting the power-supply pin with the patch electrode and a power-supply line, thereby providing the patch antenna with substantially uniform characteristics when the patch antenna is excited to emit circularly polarized radio waves.

The method may further comprise positioning the ground conductor on a surface of the printed circuit board most proximate to the patch antenna and inserting the ground terminals, the power-supply terminal, and the power-supply pin through insertion holes disposed in the printed circuit board. In this case, the method may further comprise connecting the ground terminals, the power-supply terminal, and the power-supply pin to lands on the printed circuit board that are all disposed on a surface of the printed circuit board most distal to the patch antenna, the lands being connected to different potentials.

The method may further comprise forming degeneracy breaking elements on the patch electrode that permit the patch antenna to be excited in two orthogonal modes having different resonant lengths and a phase difference of 90 degrees or may comprise inserting a second power-supply pin through the dielectric substrate and the opening of the conductive plate and connecting the second power-supply pin with the patch electrode and a second power-supply line such that the power-supply pins are configured excite the patch antenna in two orthogonal modes which have a phase difference of 90 degrees.

According to the present invention, since a layered structure is employed in which a patch antenna as a circularly-polarized-wave antenna for satellite waves is fixedly mounted on a metal plate of a plane antenna as a vertically-polarized-wave antenna for terrestrial waves and in which an opening of the plane antenna is used to connect a power-supply pin of the patch antenna to a power-supply line, a composite antenna is obtained which can receive terrestrial waves and circularly polarized waves and which can be easily reduced in thickness. In particular, the composite antenna is suitable for in-vehicle use. Also, since the metal plate of the plane antenna and a patch electrode of the patch antenna can be set to have almost circumferentially-uniform relative positional relationship, the composite antenna can easily avoid losing uniform or substantially uniform characteristics at different azimuthal angles (azimuths) which is caused by electromagnetic coupling between the plane antenna and the patch antenna. The result is stable performance in which differences in reception sensitivity caused by signals impinging on the antenna at different azimuths is reduced.

### BRIEF DESCRIPTION OF THE DRAWINGS

FIG. 1 is a perspective view of a plane antenna according to a first embodiment of the present invention;

FIG. 2 is a top view of the plane antenna;

FIG. 3 is a sectional view taken on along the line III-III in FIG. 2;

FIG. 4 is a side view of a metal plate member constituting the plane antenna;

FIG. 5 is a sectional view of a conventional plane antenna;

FIG. 6 is a perspective exploded view of a composite antenna according to a second embodiment of the present invention;

FIG. 7 is a perspective view of the composite antenna shown in FIG. 6;

FIG. 8 is a top view of the composite antenna shown in FIG. 6;

FIG. 9 is a sectional view taken on along the line IX-IX in FIG. 8;

FIG. 10 is a perspective view of a composite antenna according to a third embodiment of the present invention; and

FIG. 11 is a perspective view of another conventional composite antenna.

### DESCRIPTION OF THE PREFERRED EMBODIMENTS

A first embodiment of the present invention is described below with reference to the drawings.

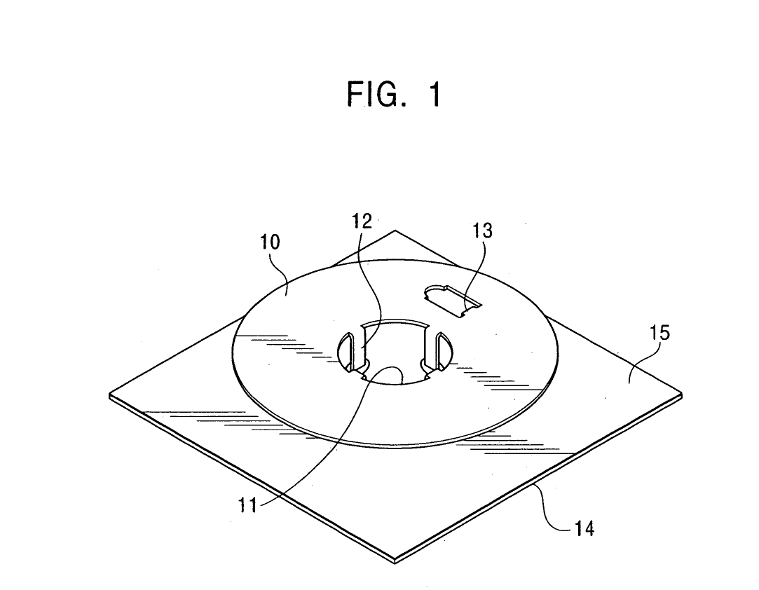

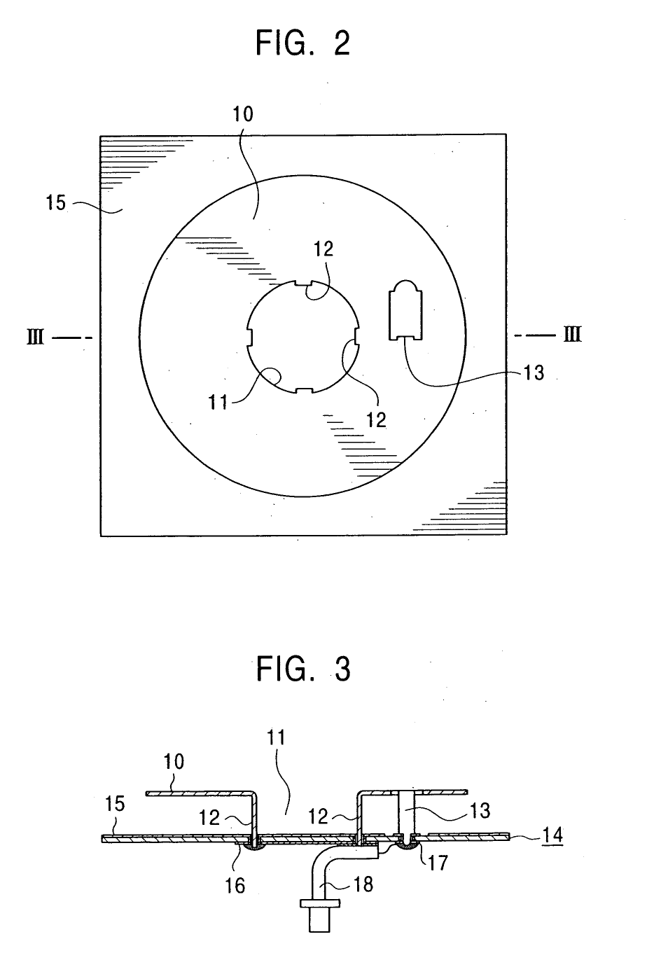

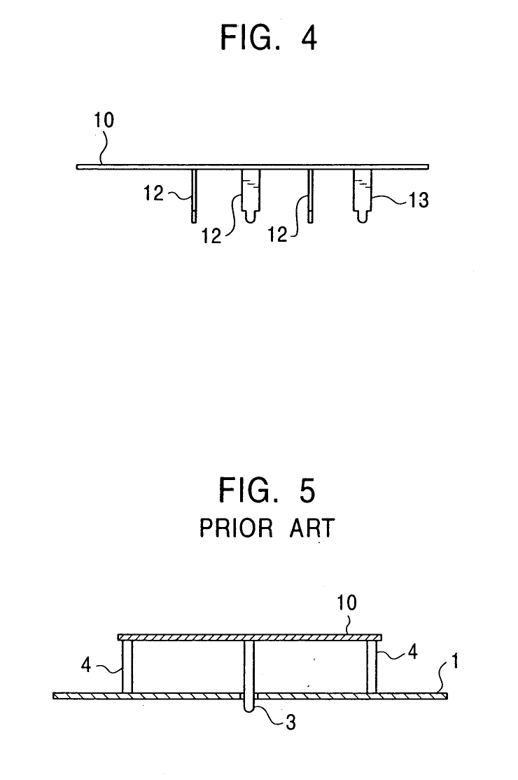

FIG. 1 is a perspective view of a plane antenna according to the first embodiment. FIG. 2 is a top view of the plane antenna shown in FIG. 1. FIG. 3 is a sectional view taken along the line III-III in FIG. 2. FIG. 4 is a side view of a metal plate of the plane antenna.

The plane antenna shown in FIGS. 1 to 4 mainly includes a circular metal plate 10 having an opening 11 in the center, four ground terminals 12 downwardly bent at the inner edge as a base end of the metal plate 10, a power-supply terminal 13 formed by cutting and pressing a portion of the metal plate 10 to bend downwardly, and a grounded conductor 15 such as copper foil which is provided on substantially (at least about 90% of) the entire top surface of a printed circuit board 14. A predetermined high frequency signal can be supplied to the power-supply terminal 13. Although the opening is illustrated as being symmetrically positioned around the exact center of the metal plate 10, the opening 11 may be slightly displaced from being symmetrically positioned around the exact center of the metal plate 10 without significantly affecting the antenna characteristics. In either case, the metal plate 10 has the shape of a washer.

Each ground terminal 12 and the power-supply terminal 13 are formed by performing blanking on portions of the metal plate 10 and subsequently bending the portions. The terminals 12 and 13, and the metal plate 10 are constituted by a single sheet of metal, i.e. the terminals are integral with the plate. The four ground terminals 12 are disposed at equal intervals, and each ground terminal 12 and the power-supply terminal 13 are formed having equal lengths. As FIG. 3 shows, on the bottom surface of the printed circuit board 14 are provided a land 16 to which the lower end of each ground terminal 12 is soldered and a land 17 to which the lower end of the power-supply terminal 13 is soldered. The land 16 is in conduction with the ground conductor 15 on the top surface side, and the power-supply line (internal conductor) of a coaxial cable 18 is soldered to the land 17. Since the terminals 12 and 13 are fixed to the printed circuit board 14, it is ensured that the metal plate 10 is supported in a stable posture by the printed circuit board 14, with a predetermined distance provided between the metal plate 10 and the ground conductor 15. The position of the power-supply terminal 13 formed on the metal plate 10 is determined by selecting an appropriate position in which their impedances match.

By appropriately setting the size of the metal plate 10 and the distance between the metal plate 10 and the ground conductor 15 so that the plane antenna is excited in the TM01 mode (the lowest resonant frequency mode), the plane antenna having the above structure emits vertically-polarized radio waves uniformly or substantially uniformly in a plane in parallel with the metal plate 10. Thus, the plane antenna can function as a vertical-polarized-wave antenna for terrestrial waves (electromagnetic waves originating from a terrestrial source) in which reception sensitivities do not differ depending on azimuths. Also, regarding the plane antenna, the metal plate 10 and the terminals 12 and 13 can be easily formed only by performing blanking on portions of a single sheet of metal and bending the portions of the sheet. As the number of components and the number of assembly steps are small, production is relatively inexpensive, and assembly precision and mechanical strength are assured. Moreover, connecting the ground conductors 12 and the power-supply terminal 13 to the lands 16 and 17 is easily performed on the bottom surface of the printed circuit board 14. Therefore, by providing a movable body such as an automobile with the plane antenna as a thin vertically-polarized-wave antenna for terrestrial waves, advantages are obtained in that uniform directional characteristics in an azimuth plane stabilizes reception sensitivity and ease in ensuring mechanical strength causes endurance against vibration and impact, and in that the price is reduced. Uniform directional characteristics are those that do not vary more than about 5% as a function of position while substantially uniform characteristics are those that do not vary more than about 20% as a function of position (preferably less than about 10%).

In the case of actually providing this type of plane antenna to a movable body such as an automobile, it is preferable to cover the antenna with a radome (not shown) In other words, by covering the plane antenna with a radome composed of dielectric material, adhesion of dust and impact of moving objects can be prevented without affecting antenna characteristics. Thus, the life of the plane antenna can be extended.

The first embodiment describes a case in which the ground conductors 12 are provided at the inner edge of the metal plate 10, which is circular, and the power-supply terminal 13 is provided between the inner edge and periphery of the metal plate 10. However, in other embodiments the power-supply terminal 13 may be provided in the center of the circular metal plate 10, and the ground conductors may be provided in the periphery. In this case, the position of each ground conductor formed in the periphery is determined by selecting an appropriate position in which impedance matching occurs. In either case, it is preferable that the exterior shape of the metal plate 10 be circular for the antenna characteristics to be uniform. However, the metal plate may have other possible exterior shapes, such as a substantially circular shape, without significantly affecting the uniform or substantially uniform characteristics of the plane antenna. Substantially circular shapes are those in which the characteristics of the plane antenna are not significantly different from circular shapes, e.g. the strength of the transmission or reception does not vary more than about 20% (preferably not more than 10%) as a function of lateral position from the antenna. Thus, substantially circular shapes include circular and regular polygonal shapes.

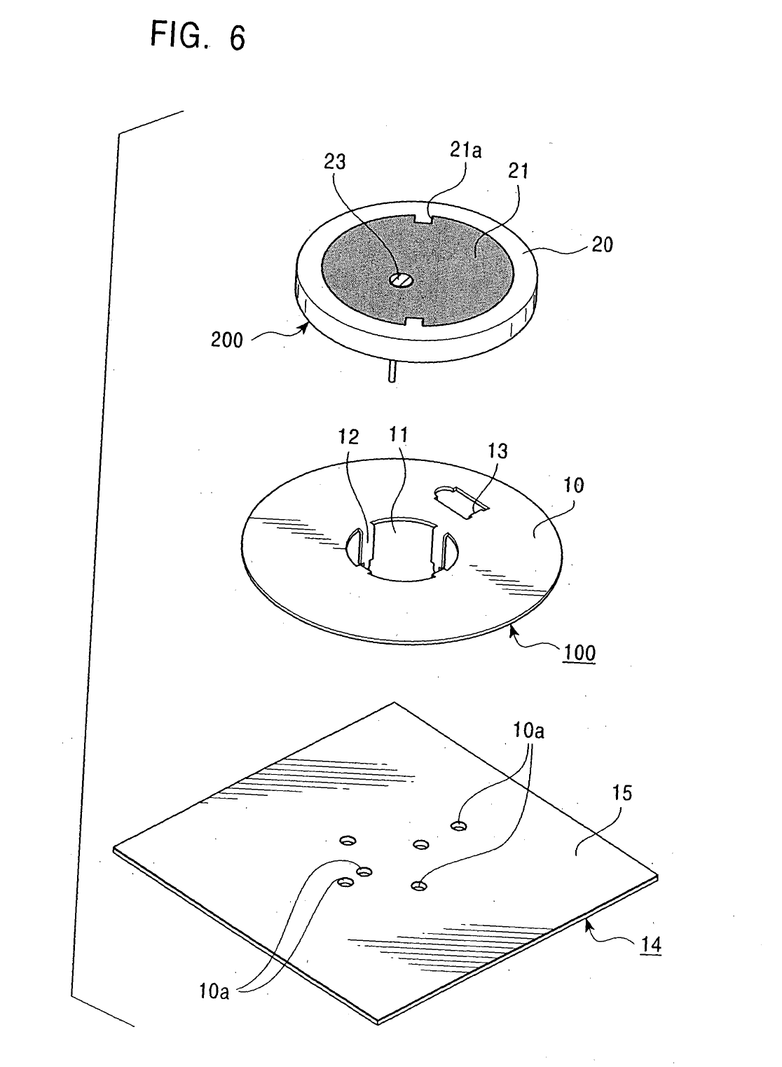

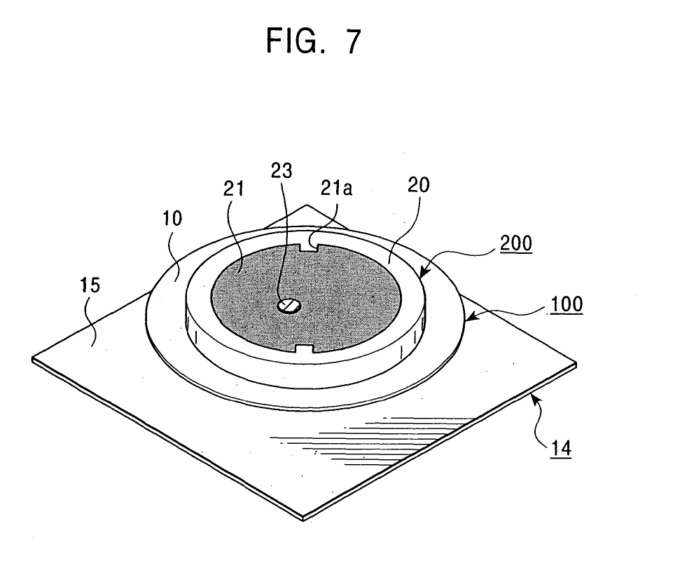

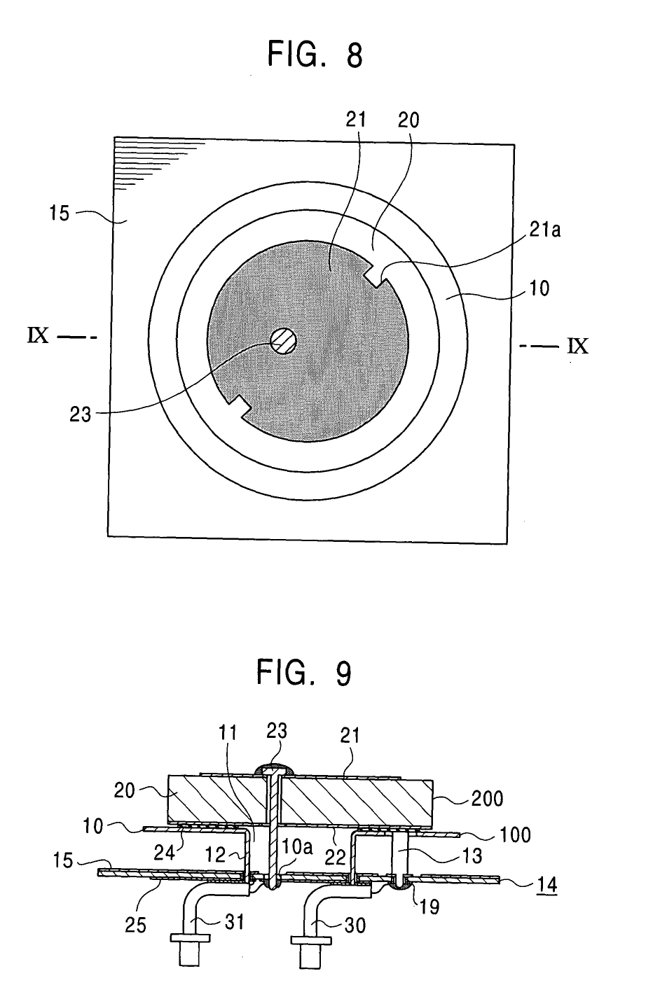

Also, other embodiments of the present invention are described below with reference to the accompanying drawings. FIG. 6 is a perspective exploded view of a composite antenna according to a second embodiment of the present invention. FIG. 7 is a perspective view of the composite antenna shown in FIG. 6. FIG. 8 is a top view of the composite antenna shown in FIG. 6. FIG. 9 is a sectional view taken on along the line IX-IX in FIG. 8.

The composite antenna shown in FIGS. 6 to 9 mainly includes a printed circuit board 14 having a plurality of insertion holes 10a in a plurality of positions, a plane antenna 100 for terrestrial waves which is held on the printed circuit board 14, and a patch antenna 200 for satellite waves (electromagnetic waves originating from a non-terrestrial source) which is held on the plane antenna 100.

The plane antenna 100 mainly includes a circular metal plate 10 having an opening 11 in the center, four ground terminals 12 downwardly bent at the inner edge as a base end of the metal plate 10, a power-supply terminal 13 formed by cutting and pressing a portion of the metal plate 10 to bend downwardly, and a grounded conductor 15 such as copper foil which is provided on the almost entire top surface of a printed circuit board 14. A predetermined high frequency signal can be supplied to the power-supply terminal 13.

Each ground terminal 12 and the power-supply terminal 13 are formed by performing blanking on portions of the metal plate 10 and subsequently bending the portions. The terminals 12 and 13, and the metal plate 10 are constituted by a single sheet of metal. The four ground terminals 12 are disposed at equal intervals, and each ground terminal 12 and the power-supply terminal 13 are formed having equal lengths. As FIG. 9 shows, the printed circuit board 14 has, on its bottom surface, a land 25 to which the bottom ends of the ground terminals 12, which pass through insertion holes 10a, are soldered, and a land 19 to which the bottom end of the power-supply terminal 13, which passes through the insertion hole 10a, is soldered. The land 25 is in conduction with the ground conductor 15 on the top surface, and a power-supply line (internal conductor) of a coaxial cable 30 is soldered to the land 19. Since the terminals 12 and 13 are fixed to the printed circuit board 14, the metal plate 10 is supported in a stable posture by the printed circuit board 14, with a predetermined distance provided between the metal plate 10 and the ground conductor 15. The position of the power-supply terminal 13 formed on the metal plate 10 is determined by selecting an appropriate position in which their impedances match.

By appropriately setting the size of the metal plate 10 and the distance between the metal plate 10 and the ground conductor 15 so that the plane antenna 100 is excited in the TM01 mode which is a lowest resonant frequency mode, the plane antenna having the above structure emits vertically-polarized radio waves uniformly or substantially uniformly in a plane in parallel with the metal plate 10. Thus, the plane antenna 100 functions as a vertical-polarized-wave antenna for terrestrial waves in which reception sensitivities do not differ depending on azimuths. Although, in the plane antenna 100, the metal plate 10 has a circular exterior shape, as above it may also have a polygonal exterior shape without substantial loss of the nondirectional characteristics as above.

A patch antenna 200 mainly includes a circular dielectric substrate 20, a substantially circular patch electrode 21 provided on the top surface of the dielectric substrate 20, a ground terminal 22 provided on substantially the entire bottom surface of the dielectric substrate 20, a power-supply pin 23 which is soldered to the patch electrode 21 and which passes through the dielectric substrate 20 and the opening 11. The power-supply pin 23 is supplied with a predetermined high frequency signal.

As FIG. 8 shows, the dielectric substrate 20 is concentrically mounted on the metal plate 10 in the plane antenna 100, with the bottom surface of the dielectric substrate 20 bonded to the metal plate 10 by a two-sided insulating tape 24 or some other permanent or temporary means. The patch electrode 21 is an emitting element having a microstrip structure, and has, in its periphery, cuts 21a (which may be projections) as degeneracy breaking elements in two symmetrical positions with reference to the center. The degeneracy breaking elements, in part, alter the circular patch into one that is substantially circular. The power-supply pin 23 is connected to the patch electrode 21 by selecting an appropriate power-supply point in which impedance matching occurs. Since the position of the power-supply point is close to the center of the patch electrode 21, it is above the opening 11 on the plane antenna 100. Therefore, there is little to no possibility that the power-supply pin 23 which leads downward from the power-supply point is in contact with the metal plate 10 and the terminals 12 and 13. The bottom end of the power-supply pin 23 passes through the insertion hole 23a and is soldered to a power-supply-line (internal conductor) of a coaxial cable 31 below the printed circuit board 14.

By appropriately setting the patch electrode 21 and the cuts 21a and exciting the patch antenna 200 in the TM11 mode, the patch antenna 200 upwardly emits circularly polarized radio waves. Thus, the patch antenna 200 functions as a circularly-polarized-wave antenna for satellite waves. In the patch antenna 200, a single point power supply method is employed which has a single power-supply point and in which, by laying degeneracy breaking elements such as the cuts 21a, two orthogonal modes with different resonant lengths have a phase difference of 90 degrees.

As described above, the composite antenna according to the second embodiment can receive terrestrial waves by using the plane antenna 100 and can receive satellite waves by using the patch antenna 200. In addition, a structure in which the patch antenna 20b is stacked on the plane antenna 100 promotes reduction in size and thickness of the entire apparatus. Accordingly, the composite antenna is suitable for use as a small in-vehicle antenna that can receive both terrestrial waves and satellite waves. The composite antenna has a circumferentially uniform relative positional relationship between the metal plate 10 and the patch electrode 21. Thus, deterioration in the uniform characteristics caused by electromagnetic coupling between the plane antenna 100 and the patch antenna 200 is reduced. This leads to stable performance in which differences in reception sensitivity caused by changes in the azimuth are reduced.

Moreover, in the plane antenna 100 employed in the composite antenna, the metal plate 10, the ground terminals 12, and the power-supply terminal 13 can be easily formed by performing blanking on portions of a sheet of metal and bending the portions. Thus, a reduced numbers of components and assembly steps are needed, thereby decreasing production costs. In addition, the assembly precision and mechanical strength are enhanced. Accordingly, the terminals 12 and 13 fixed to the printed circuit board 14 can stably support the metal plate 10 and the dielectric substrate 20, so that an inexpensive and highly reliable composite antenna can be obtained. Also, connecting the ground terminals 12 and the power-supply terminal 13 in the plane antenna 100 to the lands 18 and 19 and connecting the power-supply pin 23 in the patch antenna 200 to the coaxial cable 31 are easily performed below the printed circuit board 14.

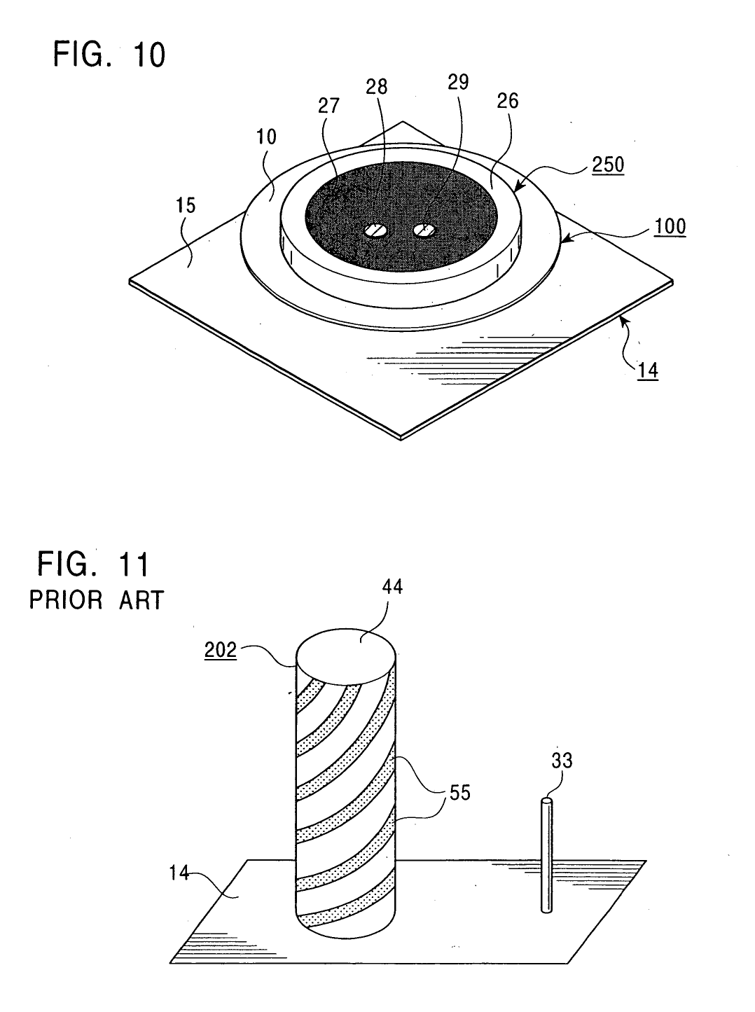

FIG. 10 is a perspective view of a composite antenna according to a third embodiment of the present invention. The entirety of a patch antenna is denoted by reference numeral 250 and components corresponding to those shown in FIG. 7 are denoted by identical reference numerals.

The composite antenna in FIG. 10 differs from the second embodiment in that the patch antenna 250 employs a two-point power-supply method and includes a 90-degree phase-difference circuit (not shown) on a printed circuit board 14. In the patch antenna 250, the top surface of a dielectric substrate 26 is provided with a patch electrode 27. Power-supply pins 28 and 29 are soldered to adjacent portions of the patch electrode 27. The adjacent portions are less than about half of the radius of the patch from each other and are offset from the center of the patch electrode 27. The bottom ends of the power-supply pins 28 and 29 are connected to the 90 degree phase-difference circuit. The patch antenna 250 can be excited in two orthogonal modes which have a phase difference of 90 degrees. Thus, the patch antenna 250 functions as a circularly-polarized-wave antenna for satellite broadcasts similarly to the patch antenna 200.

In each of the second and third embodiments, when the composite antenna is provided on a movable body such as an automobile, it is preferable to cover the composite antenna with a radome (not shown). By selecting a dielectric material for the radome, the adhesion of dust and the effects of the impact of flying objects can be reduced or prevented without affecting antenna characteristics. Thus, the life of the composite antenna can be extended.

Although in each of the embodiments, it is preferable that an integral sheet of metal is used to form the metal plate 10, the ground terminals 12, and the power-supply terminal 13, for the cost and assembly reasons given above, the ground terminals 12 and the power-supply terminal 13 may be metal pins that are separate from the metal plate 10. One may fabricate the antenna in manner if, for example, the material properties such as conductivity are required to be different from that of the metal plate. Also, although copper was discussed briefly herein as a particular metal of choice, other metals such as aluminum, gold, or silver, or other conductors may be used as desired dependent on the cost, electrical characteristics, and material characteristics (such as ductility and other characteristics germaine to processing).

Also, although the embodiments illustrated show layers, such as the ground plane, disposed on the sides (top/bottom) of the printed circuit board, these layers may be buried within the printed circuit board for added endurance, for example.

The present invention includes an antenna that can be used on movable systems, such as vehicles. While particular embodiments of the present invention have been shown, and described, modifications may be made by one of skill in the art. It is therefore intended that such modifications and changes are within in the spirit and scope of the invention.

What is claimed is:

1. A plane antenna comprising:
a printed circuit board;
a metal plate having one of a circular and a regular-polygonal shape;
a ground conductor held at a predetermined distance away from said metal plate;
ground terminals connected to said ground conductor, said ground terminals being folded members extended from said metal plate towards the ground conductor;
a power-supply terminal connected to a power-supply line, said power-supply terminal being a folded member extended from the metal plate towards said ground conductor,
wherein said plane antenna is configured to emit vertically polarized radio waves when excited in a lowest-resonant-frequency mode.

2. A plane antenna according to claim 1, wherein said printed circuit board has said ground conductor on a top surface thereof, and the metal plate is supported by said printed circuit board, with said ground terminals and said power-supply terminal provided between the metal plate and said printed circuit board.

3. A plane antenna according to claim 1, wherein:
the metal plate has an opening in a center thereof;
the metal plate has said ground terminals at an inner edge thereof; and
the metal plate has said power-supply terminal between the inner edge and an outer edge thereof.

4. A plane antenna according to claim 1, wherein the metal plate has said power-supply terminal in a center thereof, and the metal plate has said ground terminals in a periphery thereof.

5. A composite antenna comprising:
a plane antenna comprising:
a printed circuit board;
a ground conductor;
a metal plate having one of a circular and regular-polygonal shape with an opening in a center thereof, the metal plate being opposed to said ground conductor, with a predetermined distance provided between the metal plate and said ground conductor;
ground terminals for connecting the metal plate to said ground conductor; and
a power-supply terminal for connecting the metal plate to a first power-supply line; and
a patch antenna comprising:
a dielectric substrate;
a patch electrode provided on a top surface of said dielectric substrate;
ground electrodes provided on a bottom surface of said dielectric substrate;
an insulating member provided between the metal plate and said dielectric substrate so that said dielectric substrate is fixed to one surface of the metal plate; and
a power-supply pin provided so as to penetrate said dielectric substrate and to be connected to said patch electrode, said power-supply pin being connected to a second power-supply line, with said power-supply pin inserted into the opening in the center of the metal plate,
wherein said plane antenna is configured to emit vertically polarized radio waves when excited, and said composite antenna is configured to emit circularly polarized radio waves when excited.

6. A composite antenna according to claim 5, wherein:
said printed circuit board has, on a top surface thereof, said ground conductor and a plurality of insertion holes; and
said ground terminals, said power-supply terminal, and said power-supply pin are fixed to said printed circuit board, with the ground and power-supply terminals and said power-supply pin inserted into the insertion holes.

7. A composite antenna according to claim 6, wherein each of said ground terminals and said power-supply terminal is a folded member extending from the metal plate to said printed circuit board.

8. A plane antenna comprising:
a printed circuit board;
a conductive plate;
a ground conductor disposed a predetermined distance from said conductive plate, said ground conductor supported by the printed circuit board;
ground terminals extending from and integral with said conductive plate and connecting the conductive plate with the ground conductor;
a power-supply terminal extending from said conductive plate towards said ground conductor, said power-supply terminal integral with said conductive plate,
wherein said plane antenna is configured such that characteristics of said plane antenna are substantially uniform when said plane antenna is excited in a lowest-resonant-frequency mode to emit vertically polarized radio waves.

9. The plane antenna according to claim 8, wherein said ground conductor is disposed on a surface of said printed circuit board most proximate to the conductive plate, and said ground terminals and said power-supply terminal are provided between the conductive plate and said printed circuit board.

10. The plane antenna according to claim 8, wherein the conductive plate has a washer shape with inner and outer edges, said ground terminals are formed at the inner edge and said power-supply terminal is formed between the inner and outer edges.

11. The plane antenna according to claim 8, wherein the conductive plate has a washer shape with inner and outer edges, said power-supply terminal is formed at the inner edge and said ground terminals are formed at the outer edge.

12. The plane antenna according to claim 8, wherein the conductive plate has a substantially circular shape.

13. The plane antenna according to claim 12, wherein the conductive plate has a circular shape.

14. The plane antenna according to claim 12, wherein the conductive plate has a regular-polygonal shape.

15. A composite antenna comprising the plane antenna according to claim 8, and
a patch antenna comprising:
a dielectric substrate;
a patch electrode provided on a surface of said dielectric substrate most distal to the plane antenna;
ground electrodes provided on a surface of said dielectric substrate most proximate to the plane antenna;
an insulating member provided between the conductive plate and said dielectric substrate such that said dielectric substrate is fixed to a first surface of the conductive plate; and
at least one power-supply pin provided so as to penetrate said dielectric substrate and to be connected to said patch electrode, said power-supply pin being connected to a second power-supply line and inserted into an opening of the conductive plate,
wherein the patch antenna is configured to emit substantially uniform circularly polarized radio waves when excited.

16. The composite antenna according to claim 15, wherein:
a plurality of insertion holes are disposed in the printed circuit board;
said ground conductor is disposed on a surface of said printed circuit board most proximate to the patch antenna; and
said ground terminals, said power-supply terminal, and said power-supply pin are fixed to said printed circuit board, with the ground and power-supply terminals and said power-supply pin inserted into the insertion holes.

17. The composite antenna according to claim 15, wherein the patch antenna has a substantially circular shape.

18. The composite antenna according to claim 17, wherein the patch electrode has degeneracy breaking elements positioned to permit the patch antenna to be excited in two orthogonal modes having different resonant lengths and a phase difference of 90 degrees.

19. The composite antenna according to claim 18, wherein the degeneracy breaking elements are symmetrically positioned with reference to a center of the patch electrode.

20. The composite antenna according to claim 15, further comprising a plurality of power-supply pins, said power-supply pins configured excite the patch antenna in two orthogonal modes which have a phase difference of 90 degrees.

21. A method of fabricating an antenna structure having substantially uniform characteristics, the method comprising:
fabricating a plane antenna by:
shaping a conductive sheet into a substantially circular shape;
blanking portions of the conductive sheet such that a hole is formed in the conductive plate and the conductive plate has inner and outer edges and bending the portions of the sheet to form ground terminals and a power-supply terminal that are integral with the conductive sheet;
providing a printed circuit board and a ground conductor supported by the printed circuit board;
connecting the ground terminals with the ground conductor; and
extending the power-supply terminal toward the ground conductor,
thereby providing the plane antenna with substantially uniform characteristics when the plane antenna is excited in a lowest-resonant-frequency mode to emit vertically polarized radio waves.

22. The method of claim 21, further comprising forming the ground terminals at the inner edge and the power-supply terminal between the inner and outer edges.

23. The method of claim 21, further comprising forming the ground terminals at the outer edge and the power-supply terminal at the inner edge.

24. The method of claim 21, further comprising connecting the ground terminals to a first land on the printed circuit board and the power-supply terminal to a second land on the printed circuit board, the first and second lands disposed on a surface of the printed circuit board opposing a surface of the printed circuit board on which the ground conductor is disposed, the first land connected with the ground conductor and the second land connected to a power-supply line.

25. The method of claim 21, further comprising positioning the power-supply terminal to match impedances of the power-supply terminal and the conductive plate.

26. The method of claim 21, further comprising attaching the antenna structure to a movable body.

27. The method of claim 21, further comprising fabricating a patch antenna comprising:
attaching a dielectric substrate to the plane antenna with an insulating member disposed between the dielectric substrate and the plane antenna;
providing a patch electrode on a surface of the dielectric substrate most distal to the plane antenna and ground electrodes on a surface of the dielectric substrate most proximate to the plane antenna; and
inserting a power-supply pin through the dielectric substrate and the opening of the conductive plate and connecting the power-supply pin with the patch electrode and a power-supply line,
thereby providing the patch antenna with substantially uniform characteristics when the patch antenna is excited to emit circularly polarized radio waves.

28. The method of claim 27, further comprising positioning the ground conductor on a surface of the printed circuit board most proximate to the patch antenna and inserting the ground terminals, the power-supply terminal, and the power-supply pin through insertion holes disposed in the printed circuit board.

29. The method of claim 28, further comprising connecting the ground terminals, the power-supply terminal, and the power-supply pin to lands on the printed circuit board that are all disposed on a surface of the printed circuit board most distal to the patch antenna, the lands being connected to different potentials.

30. The method of claim 27, further comprising forming degeneracy breaking elements on the patch electrode that permit the patch antenna to be excited in two orthogonal modes having different resonant lengths and a phase difference of 90 degrees.

31. The method of claim 27, further comprising inserting a second power-supply pin through the dielectric substrate and the opening of the conductive plate and connecting the second power-supply pin with the patch electrode and a second power-supply line such that the power-supply pins are configured excite the patch antenna in two orthogonal modes which have a phase difference of 90 degrees.
